(19) United States
(12) Patent Application Publication
(10) Pub. No.: US 2005/0243952 A1
(43) Pub. Date: Nov. 3, 2005

(54) Methods for processing a received signal in a software defined radio (SDR) system, a transceiver for an SDR system and a receiver for an SDR system

(75) Inventor: Wenzhen Li, Singapore (SG)

Correspondence Address: OSTROLENK FABER GERB & SOFFEN, 1180 AVENUE OF THE AMERICAS, NEW YORK, NY, 100368403, US

(73) Assignee: Oki Techno Centre (Singapore) Pte Ltd

(21) Appl. No.: 11/105,892

(22) Filed: Apr. 14, 2005

(30) Foreign Application Priority Data
Apr. 28, 2004 (SG) 200402475-8

(51) Int. Cl. H04L 27/06

(52) U.S. Cl. 375/343

(57) ABSTRACT

A receiver for a software defined radio system comprises an input stage for receiving a transmitted signal, an analogue-to-digital converter having a sample rate, a filter matched to the received transmitted signal, and a sample rate converter for converting the digital signal output from the filter from an input sequence having the sample rate of the analogue-to-digital converter to an output sequence having an output sample rate defined by the received transmitted signal. The input and output sequences comprise respectively a number of input samples and a number of output samples. A controller controls the output sample rate and a demodulator coupled to the output of the sample rate converter recovers the transmitted signal. The sample rate converter is implemented by a transposed Farrow structure. The controller is arranged to reset the output sequence from the sample rate converter when any one of said number of input samples and any one of said number of output samples pass through coincidence in time.

### FIELD OF THE INVENTION

The present invention relates to methods for processing a received signal in a software defined radio (SDR) system, a transceiver for an SDR system and a receiver for an SDR system.

### BACKGROUND OF INVENTION

Software-defined radios require a programmable and dynamically reconfigurable hardware to implement the physical layer processing of multiple communication systems. Software-defined radio terminals must be able to process many various communications standards. These standards generally employ different data rates and use different master clocks. Hence, sample rate conversion (SRC) should be introduced to the signal processing of digital communication transceivers for use as software-defined radio systems.

A number of SRC solutions have been proposed, for example by Tim Hentschel and Gerhard Fettweis in “Sample rate conversion for software radio”, IEEE Communication Magazine, August 2000, pp142-150, by Tim Hentschel, Matthias Henker and Gerhard Fettweis in “The digital front end of software radio terminals”, IEEE Personal Communications, August 1999, pp6-12, by Tim Hentschel in “Sample rate conversion in software configurable radios”, Artech House, 2002, and by Ronald E. Crochiere and Lawrence R. Rabiner in “Multirate Digital Signal Processing”, Acoustics Research Department, Bell Laboratories Murrey Hill, New York. These known solutions include a multistage FIR filter, a CIC filter, and a polyphase filter. However, a number of problems exist with the use of these types of filters.

Generally, CIC filters have a narrow usable passband, a serious finite word length effect, and the problem of bit growth (filter gain). With respect to multistage FIR filters, it is difficult to choose a generic multistage architecture with appropriate stages and suitable sampling factors for each stage. At the same time, FIR filters require an extra control structure, which results in increased complexity. With regard to the polyphase filter, it is resource-consuming to use such a filter for a general purpose SRC. The reason for this is that if a rational or arbitrary factor SRC is needed, which results in a periodically time-varying system, only a certain set of samples of FIR filters is involved in the computations for each output, but all sets of coefficients should be stored and employed. Hence for a sample rate factor L/M, if L and M are large, the necessary memory size might be impractical.

To keep the complexity low in an SRC system with an arbitrary conversion factor, one known solution is to use a polynomial filter describing continuous time impulse responses. The use of Farrow structure in such a system is an efficient implementation form having only one tunable parameter. The Farrow structure can provide an efficient way to implement sampling rate increases as such a structure has good anti-image capability. Similarly, transposed Farrow structure is known to be suitable for sample rate decreases due to its good anti-aliasing capability.

The combination of a matched filter, an SRC and an interpolator for symbol timing recovery into one FIR using polyphase or Farrow approaches has been described in a number of documents, for example, by Matthias Henker and Gerhard Fettweis in “Combined filter for sample rate conversion, matched filtering, and symbol synchronization in software radio terminals”, Proc. of European Wireless 2000, Sep. 12-14, Dresden, German, pp61-66, by Fredric J. Harris and Michael Rice in “Multirate digital filters for sysmbol timing synchronization in software defined radios”, IEEE Journal on Selected Areas in Communications, Vol. 19, No. 12, December 2002, pp2346-2357, and by Ridha Hamila, Jussi Vesma, and Markku Renfors in “Polynomial-Based Maximum-Likehood Technique for Synchronizatin in Digital Receivers”, IEEE Transaction on Circuits and Systems-II: Analog and Digital Signal Processing, Vol. 49, No. 8, August 2002, pp567-576.

In such systems in which a matched filter, an SRC and an interpolator for symbol timing recovery are combined into one FIR using polyphase or Farrow approaches, the initialization and calculation of the single changeable parameter (inter-sample position u) will determine the overall system performance, which is very important for system implementation.

There are two known classes of inter-sample position sequence generation methods. Although these methods claim to be able to meet the spectral requirements in a purely SRC system, the applicants have appreciated that there are numerous problems associated with these assertions. In particular, the scheme described by Matthias Henker and Gerhard Fettweis in “Combined filter for sample rate conversion, matched filtering, and symbol synchronization in software radio terminals”, Proc. of European Wireless 2000, Sep. 12-14, Dresden, German, pp61-66 results in unreasonably decimated symbols due to inaccurate mathematical basis. Furthermore, although the scheme described by Tim Hentschel and Gerhard Fettweis, in “Continuous-time digital filters for sample rate conversion in reconfigurable radio terminals”, Proc. of European Wireless 2000, Sep. 12-14, Dresden, German, pp55-59 points in the right direction for the sequence generation, a feasible generation method has not yet been proposed.

A simplified method, which generates a constant inter-sample position sequence for an integer SRC system was proposed by Tim Hentschel in “Sample rate conversion in software configurable radios”, Artech House, 2002, as an attempt to solve this problem. Although the scheme described therein is claimed to solve the problem partially by shifting a constant timing phase

$$\frac{1}{M} ,$$

the problem still exists even in an integer SRC system, as the sampling phase shift may be fatal for the multifunctional transposed Farrow structure in a timing phase sensitive SDR system. This is the biggest factor that hinders the extensive potential application of Transposed Farrow structure in SDR systems.

Thus, there is a need for a receiver and transmitter structure for use in an SDR system which operates in both rational and non-rational SRC conditions.

### SUMMARY OF THE INVENTION

According to a first aspect of the invention there is provided a receiver for a software defined radio (SDR) system comprising: an input stage for receiving a transmitted signal; an analogue-to-digital converter for converting the transmitted signal to a digital signal, the analogue-to-digital converter having a sample rate; a filter matched to the received transmitted signal; a sample rate converter for converting the digital signal output from the filter from an input sequence having the sample rate of the analogue-to-digital converter to an output sequence having an output sample rate defined by the received transmitted signal, the input sequence comprising a number of input samples, and the output sequence comprising a number of output samples; a controller for controlling the output sample rate according to a predetermined timing sequence selected by the received transmitted signal; and a demodulator coupled to the output of the sample rate converter for recovering said transmitted signal; wherein the sample rate converter is implemented by a transposed Farrow structure; and wherein said controller is arranged to reset the output sequence from the sample rate converter when any one of said number of input samples and any one of said number of output samples pass through coincidence in time.

The receiver may further comprise: a channel selection stage for selecting a channel associated with said transmitted signal; and a symbol timing synchronisation stage, said symbol timing synchronisation stage being arranged to synchronise an output signal of the sample rate converter with said demodulator.

One or more of the channel selection stage, the filter, the symbol timing synchronisation stage and the controller may be implemented by a transposed Farrow structure.

The controller may comprise an accumulator overflow controller.

In that case, the controller may be arranged to reset the output sequence from the sample rate converter when the sum of the time interval between an output sample and a previous input sample and the ratio of the time interval between consecutive input samples to the time interval between consecutive output samples is greater than 1, which signifies that any one of said number of input samples and any one of said number of output samples pass through coincidence in time.

The receiver may further comprise a memory store for storing at least one of: a number of initialization values of the time interval between an output sample and a previous input sample; and a number of initial values of a number of predetermined timing sequences to be selected by the received transmitted signal.

The transposed Farrow structure may comprise an updater for updating the time interval between an output sample and a subsequent input sample. The updater may be arranged to update the time interval between an output sample and a subsequent input sample by subtracting the ratio of the time interval between consecutive input samples to the time interval between consecutive output samples from the value of the time interval between the previous output sample and previous input sample.

The updater may be arranged to update the time interval between an output sample and a subsequent input sample by adding the ratio of the time interval between consecutive input samples to the time interval between consecutive output samples to the value of the time interval between the previous output sample and previous input sample.

According to a second aspect of the invention there is provided a transceiver for a software defined radio system comprising the receiver defined above. The transceiver may further comprise a transmitter for transmitting signals to said receiver, said transmitter comprising a Farrow structure, said Farrow structure being arranged to implement one or more of digital up-conversion, pulse shaping and sample rate conversion.

According to a third aspect of the invention there is provided a method for processing a received signal in a receiver of a software defined radio system, the method comprising the steps of: receiving a transmitted signal; converting the transmitted signal in an analogue-to-digital converter to a digital signal, the analogue-to-digital converter having a sample rate; filtering said digital signal using a filter matched to the received transmitted signal; converting in a sample rate converter the digital signal output from the filter from an input sequence having the sample rate of the analogue-to-digital converter to an output sequence having an output sample rate defined by the received transmitted signal, the input sequence comprising a number of input samples, and the output sequence comprising a number of output samples; controlling the output sample rate according to a predetermined timing sequence selected by the received transmitted signal; and demodulating the received transmitted signal in a demodulator coupled to the output of the sample rate converter for recovering said transmitted signal; wherein the step of converting in a sample rate converter is implemented by a transposed Farrow structure; and wherein the step of controlling the output sample rate comprises resetting the output sequence from the sample rate converter when any one of said number of input samples and any one of said number of output samples pass through coincidence in time.

The method may further comprise: selecting a channel associated with said transmitted signal; and synchronising in a symbol timing synchronisation stage an output signal of the sample rate converter with said demodulator.

One or more of the channel selection stage, the filter, the symbol timing synchronisation stage and the controller may be implemented by a transposed Farrow structure.

The step of controlling the output sample rate may comprise controlling an accumulator overflow.

The step of controlling the output sample rate may comprise resetting the output sequence from the sample rate converter when the sum of the time interval between an output sample and a previous input sample and the ratio of the time interval between consecutive input samples to the time interval between consecutive output samples is greater than 1, which signifies that any one of said number of input samples and any one of said number of output samples pass through coincidence in time.

The method may further comprise storing at least one of: a number of initialization values of the time interval between an output sample and a previous input sample; and a number of initial values of a number of predetermined timing sequences to be selected by the received transmitted signal.

The method may further comprise updating the time interval between an output sample and a subsequent input sample using the transposed Farrow structure.

The step of updating may comprise updating the time interval between an output sample and a subsequent input sample by subtracting the ratio of the time interval between consecutive input samples to the time interval between consecutive output samples from the value of the time interval between the previous output sample and previous input sample.

The step of updating may comprise updating the time interval between an output sample and a subsequent input sample by adding the ratio of the time interval between consecutive input samples to the time interval between consecutive output samples to the value of the time interval between the previous output sample and previous input sample.

According to a fourth aspect of the present invention there is provided a method of transmitting and receiving signals in a software defined radio (SDR) system comprising the method defined above.

According to a fifth aspect of the present invention there is provided a method of transmitting and receiving signals in a software defined radio (SDR) system comprising the method defined above, further comprising transmitting signals from a transmitter to said receiver, said transmitter comprising a Farrow structure to implement one or more of digital up-conversion, pulse shaping and sample rate conversion.

Embodiments of the present invention are very suitable for DSP and ASIC implementation. Furthermore, embodiments of the invention provide a programmable and dynamically reconfigurable common hardware platform having multipurpose filtering.

In a preferred embodiment, a polynomial-based transposed Farrow structure is adopted in an SDR system to realize the multiple functions of the SRC, matched filter and timing adjustment.

The analysis and simulation results set out below show that the proposed solutions embodying the invention are a practical implementation of transposed Farrow structure enabling potentially extensive applications in SDR systems.

### BRIEF DESCRIPTION OF THE DRAWINGS

The present invention will now be described by way of example and with reference to the accompanying drawings, in which:

FIG. 1 shows a conventional baseband transceiver architecture for a Bluetooth system;

FIG. 2 shows a conventional baseband transceiver architecture for a WLAN system;

FIG. 3 shows a typical conventional common hardware platform for an SDR baseband transceiver;

FIG. 4 shows a common hardware platform for an SDR baseband transceiver according to an embodiment of the invention;

FIG. 5 shows the circuitry of conventional transposed Farrow structure;

FIG. 6 shows a timing diagram of an inter-sample position calculation method for use in an embodiment of the invention;

FIG. 7 shows a timing diagram of a conventional inter-sample position calculation method;

FIG. 8 shows the theoretical BER performance of various modulation schemes;

FIG. 9 shows the BER performance of various modulation schemes with a conventional inter-sample position calculation method; and

FIG. 10 shows the BER performance of various modulation schemes with a proposed inter-sample position calculation method according to an embodiment of the invention.

### DESCRIPTION OF PREFERRED EMBODIMENTS

For simplicity, an indoor wireless communication SDR system is considered, which provides a programmable and dynamically reconfigurable common hardware to implement the physical layer processing of Bluetooth 1.1 and WLAN 802.11g systems. The following has been described, by way of example, and in the context of DSSS mode. However, it should be noted that methods and apparatus according to preferred embodiments of the present invention may be extended to other SDR systems.

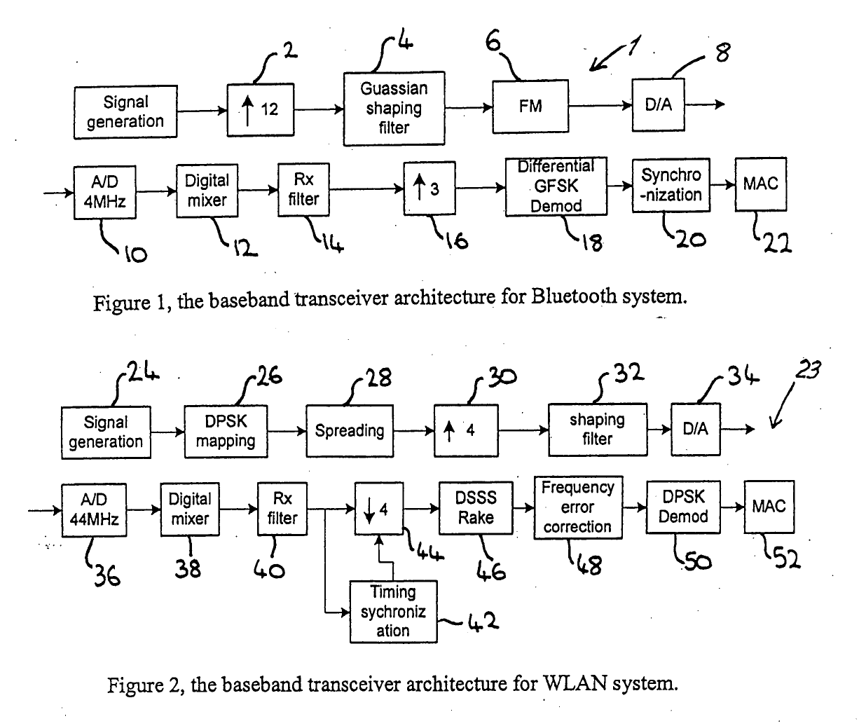

The transceiver 1 for a conventional Bluetooth 1.1 system is shown in FIG. 1. In the transmitter section of the transceiver 1, the incoming digital signal (which may be generated by a signal generator) is passed to an up-sampling stage 2 in which the bit rate of the signal is raised. The signal is then passed to a pre-modulation Gaussian low pass filter 4 which is required for GFSK modulation systems, to reduce the frequency discontinuity and to improve the spectrum utilization. The output of the filter 4, is connected to a frequency modulator 6 and the resulting modulated signal output from the frequency modulator 6 is converted to analogue mode in a digital-to-analogue converter 8. The analogue signal is then passed to the transmission stage (not shown).

In the receiver section of the Bluetooth 1.1 system 1, the received signal is first digitised in an analogue-to-digital converter stage 10. The digitised signal is passed to a digital mixer 12 and the signal output from the digital mixer 12 is passed to a receiver low pass filter 14, which is preferably a matched filter, to maximize the receiver signal-to-noise-ratio (SNR). The output of the receiver filter 14 is connected to an up-sampling stage 16 in which the signal is up-sampled with, for example, a 12 MHz clock (not shown) to increase the demodulation performance. The output of the up-sampling stage 16 is connected to a differential GFSK demodulator 18. The output of the demodulator 18 is connected to a synchronisation stage 20 where synchronisation is performed on the signal to recover the transmitted data. The output of the synchronisation stage 20 is connected to a MAC filter 22 to reproduce the signal passing through the system.

The conventional transceiver 1 for the Bluetooth 1.1 system illustrated in FIG. 1 adopts 2-level GFSK modulation and its channel bandwidth is 1 MHz. In the transmitter section, a modulation index of 0.32 and BT of 0.5 are considered, and the over-sampling factor of the up-sampling stage 2 is assumed to be 12, thus the D/A sampling rate is 12 MHz.

In the receiver section of the Bluetooth 1.1 system illustrated in FIG. 1, to attain low power consumption and a low cost design, a 4 MHz analogue-to-digital converter 10 is used. This arrangement also substantially decreases the complexity of the digital mixer 12 which produces a low-intermediate frequency (IF) architecture of, for example, 1 MHz.

FIG. 2 shows a typical transceiver baseband system model 23 for a WLAN operating in the 802.11b DSSS mode. In the transmitter section, a signal generator 24 generates an input signal for the system of FIG. 2. The data rate of the signal generator 24 is 1 Mbps for DBPSK modulation and 2 Mbps for DQPSK modulation. The input signal is converted into a DPSK modulated signal in a DPSK mapping stage 26 the input of which is connected to the output of the signal generator 24. The output of the mapping stage 26 is connected to a spreading stage 28, where the Barker sequence is used as the PN sequence to spread the spectrum of the modulated DPSK signal, whose chip rate is 11 MHz. The output of the spreading stage 28 is passed to an up-sampling stage 30, where the chip rate is raised to 44 MHz. The output of the up-sampling stage 30 is connected to the input of a shaping filter 32. The shaping filter 32 shapes the transmission signal pulse to meet the spectrum mask requirement in the specification. The shaped signal pulse is then converted to analogue format in a digital-to-analogue converter 34 for transmission. In the transmitter stage, the channel bandwidth considered is 11 MHz, and the A/D and D/A sampling rates are assumed to be 44 MHz, thus an over-sampling factor of 4 is adopted.

In the receiver stage of the system of FIG. 2, the received signal is digitised in an analogue-to-digital converter 36 and then passed to a digital mixer 38 to reduce the signal to the IF frequency. The output of the digital mixer 38 is passed to a receiver filter 40. The receiver filter 40 is used to maximize the receiver SNR. The output of the receiver filter 40 is connected to a timing synchronisation stage 42 and an input of a down-sampling stage 44, in which the chip rate is returned to 11 MHz. The output of the timing synchronisation stage 42 is also coupled to a further input of the down-sampling stage 44 to correct the chip timing. The corrected signal is then passed through a DSSS rake 46 to a frequency error correcting stage 48. After the timing adjustment and frequency error correction, the received signal may be demodulated correctly in a DPSK demodulator 50 coupled to the output of the frequency error correcting stage 48. The output of the DPSK demodulator 50 is connected to a MAC filter 52 to reproduce the signal passing through the system.

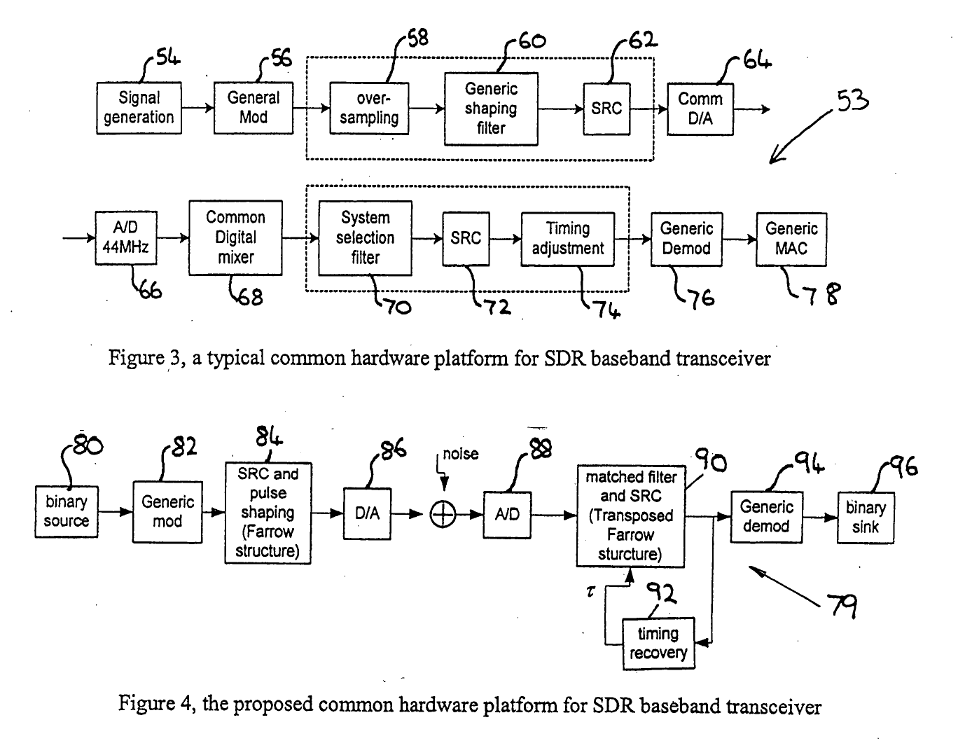

FIG. 3 shows a conventional common hardware platform 53 for an SDR baseband transceiver. The platform is based on the baseband transceiver models in FIGS. 1 and 2. As the systems shown in FIGS. 1 and 2 employ a number of common stages, it is possible, by employing the Software Defined Radio concepts and the corresponding techniques, to define the programmable and dynamically reconfigurable common hardware platform shown in FIG. 3 and to define standard specific software to meet the requirements of various systems.

In the transmitter section of the system of FIG. 3, the signal to be transmitted may be generated in a signal generator 54. The signal is then passed through a general modulator stage 56 to modulate the signal and the resulting modulated signal is passed to an over-sampling stage 58, followed by a generic shaping filter 60 and a sample rate converter 62. The output signal from the sample rate converter 62 is then converted to analogue format in a digital-to-analogue converter 64, for transmission.

In the receiver section of the system of FIG. 3, the received signal is digitised in an analogue-to-digital converter 66 and the digitised signal is passed to a digital mixer 68 having an intermediate frequency output. The intermediate frequency output from the mixer 68 is passed to a system selection filter 70, to determine the type of modulation that has been applied to the signal. The signal is then passed to a further sample rate converter 72. The converted signal is then passed through a timing adjustment stage 74, the output of which is passed to a generic demodulator 76 to recover the transmitted signal. The output of the demodulator 76 is connected to a MAC filter 78 to reproduce the signal passing through the system.

The digital front end (DFE) of the receiver branch of the system shown in FIG. 3 may be considered to include the functions of digital down conversion, channelisation, matched filtering, and sample rate conversion. Thus, it includes the digital mixer 68, system selection filter 70, and the sample rate converter 72. In the transmitter branch, the DFE may be considered to include the functions of digital up-conversion, pulse shaping and sample rate conversion in the transmitter branch. Thus, it includes the over-sampling stage 58, the shaping filter 60 and the sample rate converter 62.

The DFE interfaces the analogue/digital interface (A/D converter 66 in the receiver branch and D/A converter 64 in the transmitter branch) on one side, and the baseband processing on the other side. It has the required flexibility and parameterizability of a software defined radio system which may be adapted for different air interfaces.

In the DFE, filtering is required for many purposes, for example, for channelization, matched filtering, and pulse shaping. Often, these filtering tasks are intermeshed with decimation and interpolation tasks. In general, the combination of filtering with decimation or interpolation permits very efficient implementations such as polyphase filters. However, as mentioned in the Background to the Invention section, this is not efficient when a non-rational or arbitrary factor sampling rate conversion is needed.

The applicants have appreciated that one way to solve the aforementioned efficiency problem is to use Farrow structure and transposed Farrow structure, based on a continuous time impulse response of a filter, to implement the multi-tasks of filtering, SRC and timing adjustment and such a system is shown in FIG. 4.

FIG. 4 shows a common hardware platform 79 for an SDR baseband transceiver according to a preferred embodiment of the invention. In the transmitter section, the signal to be transmitted is obtained from a binary source 80 and the signal is then modulated onto a carrier in a generic modulator 82. The output of the modulator 82 is connected to a Farrow structure 84 which is used to implement multi-purpose filtering, including the functions of a pulse shaping, SRC and channelization. The interpolation task may also be intermeshed due to the excellent anti-imaging property of the Farrow structure 84. The output signal from the Farrow structure 84 is converted to analogue mode in a digital-to-analogue converter stage 86 prior to transmission.

In the receiver section of the system shown in FIG. 4, the received signal, together with any noise acquired during transmission, is digitised in an analogue-to-digital converter stage 88 and the digitised output signal therefrom is taken to a first input of a transposed Farrow structure 90. The transposed Farrow structure 90 is used to implement multi-purpose filtering, including matched filtering, SRC and channel selection. The decimation and timing adjustment may also be intermeshed due to the excellent anti-aliasing properties of the transposed Farrow structure 90. The transposed Farrow structure 90 also comprises a controller for controlling the reset of the intersample position sequence when any one of a number of input samples and any one of a number of output samples pass through coincidence in time.

The output of the transposed Farrow structure 90 is connected firstly to the input of a timing recovery stage 92. The output of the timing recovery stage 92 is connected back to a second input of the transposed Farrow structure 90. The output of the transposed Farrow structure 90 is connected secondly to the input of a generic demodulator 94 where the signal is demodulated to recover the information being transmitted. The output of the generic demodulator 94 is connected to a binary sink 96.

The adoption of a polynomial reconstruction filter comprising a Farrow structure and a transposed Farrow structure, which describe continuous time impulse responses, may reduce the calculation required to obtain the samples of the impulse response h(t) for the application of a non-rational or an arbitrary factor SRC.

Expanding upon the ideals presented in the Tim Hentschel and Gerhard Fettweis document, “Continuous-time digital filters for sample rate conversion in reconfigurable radio terminals”, Proc. of European Wireless 2000, Sep. 12-14, Dresden, German, pp55-59, and the Matthias Henker and Gerhard Fettweis document, “Combined filter for sample rate conversion, matched filtering, and symbol synchronization in software radio terminals”, Proc. of European Wireless 2000, Sep. 12-14, Dresden, German, pp61-66, the applicants have appreciated that the reconstruction filter may be represented by a set of piecewise polynomials, and each piece of the polynomials has equal degree and covers equal length. The length T of each piece of the polynomials corresponds to the delay between taps in the delay network in the polynomial reconstruction filter. By appropriate choice of the length T of each piece of the polynomials, the filter may be simplified considerably and a hardware structure may be derived.

If T is set to a first predetermined length T₁, that is the input signal sampling interval, the hardware structure may comprise Farrow structure. Farrow structure is described in the C. W. Farrow, document “A Countinuously Variable Digital Delay Element”, Proc. IEEE International Symposium on Circuits and Systems (ISCAS'88), pp2642-2645, Espoo, Finland, June 1988.

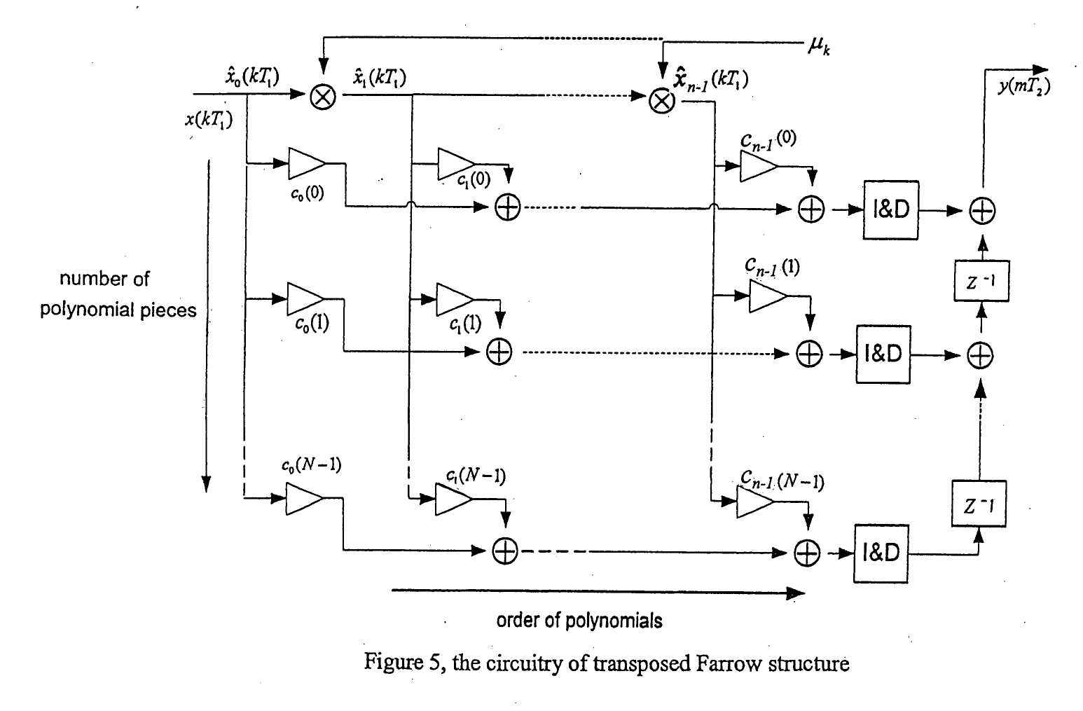

However, if T is set to a second predetermined length T₂, that is the output signal sampling interval, transposed Farrow structure may be derived. Conventional transposed Farrow structure is shown in FIG. 5 and is described in detail in the Tim Hentschel and Gerhard Fettweis document “Continuous-time digital filters for sample rate conversion in reconfigurable radio terminals”, Proc. of European Wireless 2000, Sep. 12-14, Dresden, German, pp55-59 the contents of which are incorporated herein by reference.

In the implementation of Farrow and transposed Farrow structures, inter-sample position is the only tunable parameter which substantially influences the system performance. Thus, the accurate calculation of inter-sample position is very important. For an integer sample rate factor, the inter-sample position is constant, whilst for a non-integer sample rate factor, the inter-sample factor is time-varying. In the non-integer sample rate factor case, the initialization and generation of the inter-sample position sequence uₖ is particularly important.

Various known methods for calculating uₖ based on different methods of simplifying the expression

$$⌊ m - k \frac{{T}_{1}}{{T}_{2}} ⌋$$

have been proposed in prior art documents. For example, in the Tim Hentschel and Gerhard Fettweis document entitled “Continuous-time digital filters for sample rate conversion in reconfigurable radio terminals”, Proc. of European Wireless 2000, Sep. 12-14, Dresden, German, pp55-59, one possible method is proposed, namely that

$$⌊ m - k \frac{{T}_{1}}{{T}_{2}} ⌋$$

should be simplified to

$$m - ⌈ \frac{{kT}_{1}}{{T}_{2}} ⌉ ,$$

and hence uₖ can be rewritten as,

$${u}_{k} = ⌈ \frac{{kT}_{1}}{{T}_{2}} ⌉ - \frac{{kT}_{1}}{{T}_{2}} , {u}_{k} ∈ [ 0 , 1 ) \qquad ( 1 )$$

Whilst the method proposed above is known from the Tim Hentschel and Gerhard Fettweis document entitled “Continuous-time digital filters for sample rate conversion in reconfigurable radio terminals”, Proc. of European Wireless 2000, Sep. 12-14, Dresden, German, pp55-59, no operational method of implementing the method was disclosed in the document.

The above equation (1) appears to provide a mathematical expression of inter-sample position u for each input sample, that is, the inter-sample position u is measured from the output sample to the subsequent input sample.

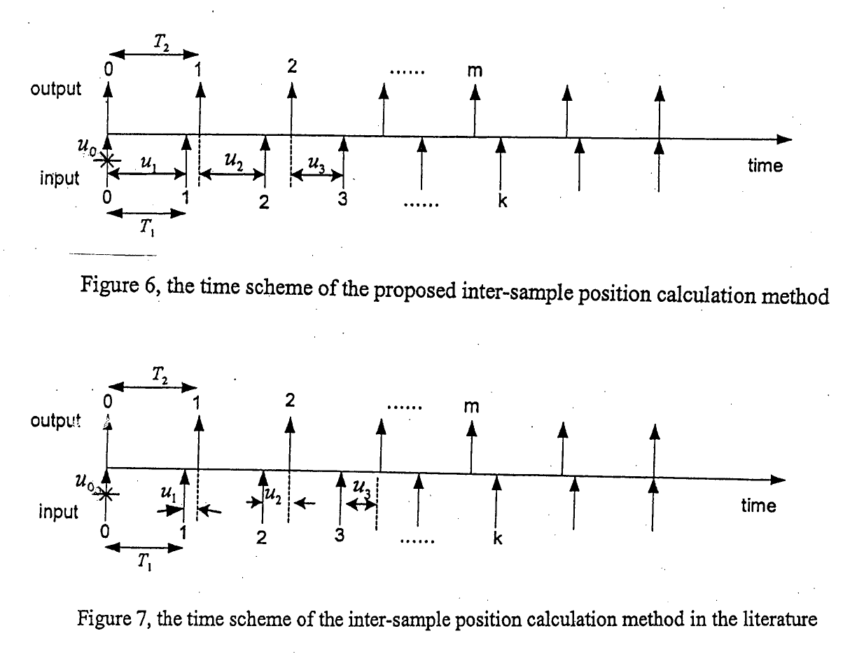

The inter-sample position sequence in accordance with equation (1) is shown in FIG. 6. In FIG. 6, the positions of the input samples spaced at intervals of T₁ are shown below the time-axis and the positions of the output samples spaced at intervals of T₂ are shown above the time-axis. The inter-sample positions u, measured from the output samples to the subsequent input samples are also shown in FIG. 6.

However, as the input index k (which is the number of input samples counted from the origin) increases with service time, it is impossible to register this real-time index, which can be up to an infinite number in continuous communications. Moreover, this equation (1) does not delimit the interval of the Integration and Dump (I&D) circuit of the transposed Farrow structure shown in the FIG. 5. Therefore, equation (1) does not provide any applicable means for extracting the definite set of inter-sample positions uₖ for each output sample y(m) from the polynomial reconstruction filter.

In contrast to the method described in the Tim Hentschel and Gerhard Fettweis document entitled “Continuous-time digital filters for sample rate conversion in reconfigurable radio terminals”, Proc. of European Wireless 2000, Sep. 12-14, Dresden, German, pp55-59, in the Matthias Henker and Gerhard Fettweis document entitled “Combined filter for sample rate conversion, matched filtering, and symbol synchronization in software radio terminals”, Proc. of European Wireless 2000, Sep. 12-14, Dresden, German, pp61-66 another means of initialization and calculation of inter-sample position was proposed which was based on the assumption that

$$⌊ m - k \frac{{T}_{1}}{{T}_{2}} ⌋$$

should be simplified to

$$m - ⌊ \frac{{kT}_{1}}{{T}_{2}} ⌋ .$$

The detailed inter-sample position calculation circuitry was also proposed in the Matthias Henker and Gerhard Fettweis document entitled “Combined filter for sample rate conversion, matched filtering, and symbol synchronization in software radio terminals”, Proc. of European Wireless 2000, Sep. 12-14, Dresden, German, pp61-66, for the DSP or ASIC implementation where only a certain precision is available. This inter-sample position calculation method is represented schematically by the timing diagram shown in FIG. 7.

FIG. 7 is similar to FIG. 6 except that in FIG. 7 the inter-sample position u is measured from the input sample to the subsequent output sample.

The above two methods, that is the method described in the Tim Hentschel and Gerhard Fettweis document entitled “Continuous-time digital filters for sample rate conversion in reconfigurable radio terminals”, Proc. of European Wireless 2000, Sep. 12-14, Dresden, German, pp55-59, and the method described in the Matthias Henker and Gerhard Fettweis document entitled “Combined filter for sample rate conversion, matched filtering, and symbol synchronization in software radio terminals”, Proc. of European Wireless 2000, Sep. 12-14, Dresden, German, pp61-66 are therefore in conflict with each other.

In an SRC system with a sample rate decrease, the inter-sample position sequence uₖ is the interval sequence of the input sequent {x(k)} referring to the unique mth output sample y(m), not the interval sequence of the output sequent {y(m)} referring to the unique kth input sample x(k). Thus, FIG. 6 instead of FIG. 7 represents this SRC scenario and it can be confirmed that the mathematical fundamental in FIG. 6 is correct for use with Farrow structure and transposed Farrow structure.

However, although the first method described above and illustrated in connection with FIG. 6 points in the correct direction, there is no feasible sequence generation solution proposed in the prior art due to there being no workable overflow control algorithm available, which is imperative for the implementation of the integrate and dump circuitry in the transposed Farrow structure.

To solve this problem, in the document by Tim Hentschel entitled “Sample rate conversion in software configurable radios”, Artech House, 2002, a constant inter-sample position sequence generation method is disclosed for an integer SRC system. For an integer sample rate decrease M, the inter-sample position is given by:

$${u}_{k} = \frac{M - 1 - k mod M}{M} ∈ [ 0 , 1 ) , k = 0 , 1 , … , M - 1 \qquad ( 2 )$$

The down sampled and filtered signal is obtained by stepping through all k=0, . . . ,L-1 sequentially for each new input sample. Thus, for M input samples, one output sample is generated. Hence the integrate and dump interval is

$${\sum }_{k mod M}^{M - 1} ( r ( k ) ) ,$$

where r(k) is the input of the integrate and dump circuit. With the algorithm (2), the inter-sample position sequence is

$$( \frac{M - 1}{M} , \frac{M - 2}{M} , … , \frac{1}{M} , 0 ) ,$$

and the overflow condition can be set as uₖ₊₁>uₖ. However, according to FIG. 6, for each output sample, the inter-sample position set should be

$$( 0 , \frac{M - 1}{M} , \frac{M - 2}{M} , … , \frac{1}{M} ) .$$

Thus, the simplified algorithm (2) partially solves the problem of overflow control by shifting the inter-sample position sequence by

$$\frac{1}{M} .$$

For a simple SRC system where the transposed Farrow structure is only used for anti-aliasing and variable delay, a constant sampling phase delay does not change the spectrum properties of the equivalent FIR filter, which has been elaborated by the results shown in the document by Tim Hentschel and Gerhard Fettweis entitled “Continuous-time digital filters for sample rate conversion in reconfigurable radio terminals”, Proc. of European Wireless 2000, Sep. 12-14, Dresden, German, pp55-59 and in the document by Matthias Henker and Gerhard Fettweis entitled “Combined filter for sample rate conversion, matched filtering, and symbol synchronization in software radio terminals”, Proc. of European Wireless 2000, Sep. 12-14, Dresden, German, pp61-66. However, there still exists a problem even in this integer SRC system when applied to multi-purpose SDR applications.

In such applications, the sampling phase shift of

$$\frac{1}{M}$$

may be fatal in an SDR system where a receiver matched filter and an SRC are integrated in the transposed Farrow structure. For example, in a noise impaired system where M is small (for example, M<16), a constant timing error of

$$\frac{1}{M}$$

is introduced into the receiver, which will substantially degrade the system performance. Therefore, a workable inter-sample position generation method is required for SDR applications where the matched filter, SRC and symbol timing synchronization are integrated in a transposed Farrow structure.

As shown in FIG. 6, for the 0th output, the inter-sample position sequence is (u₀, u₁, u₂, . . . ). At first sight it is difficult to define an overflow condition to discriminate the starting inter-sample position uₒ from the previous one. However, a new resampled output is formed when kT₁/T₂ is infinitely close to an integer, where k is the number of input samples counted from the origin. Namely, when

$$\frac{{kT}_{1}}{{T}_{2}} = {{lim}_{ɛ -> 0}}^{n \pm ɛ} ,$$

where n is the number of output samples counted from the origin, it is the time to generate the reset signal ov(m). In this case, for

$$\frac{{kT}_{1}}{{T}_{2}} = {{lim}_{ɛ -> 0}}^{n + ɛ} ,$$

the sequence uₖ is

$$( 1 , 1 - \frac{{T}_{1}}{{T}_{2}} , 1 - \frac{2 {T}_{1}}{{T}_{2}} , … ) ;$$

while for

$$\frac{{kT}_{1}}{{T}_{2}} = {{lim}_{ɛ -> 0}}^{n - ɛ} ,$$

the sequence uₖ is

$$( 0 , 1 - \frac{{T}_{1}}{{T}_{2}} , 1 - \frac{2 {T}_{1}}{{T}_{2}} , … ) .$$

From FIG. 6, it will be seen that uₖ=0 and uₖ=1 are equivalent. This shows that with a reasonable overflow controller, the inter-sample position set should be uniquely defined.

The overflow controller detects the time at which a new output sample is generated. According to a preferred embodiment, a new variable index indexₖ₊₁ is introduced for the overflow accumulator, which is defined as:

$${index}_{k + 1} = {index}_{k} + \frac{{T}_{1}}{{T}_{2}} mod1$$

and the overflow signal is:

$$ov ( m ) = {index}_{k} \frac{{T}_{1}}{{T}_{2}} > 1$$

Thus,
uₖ=1−indexₖ

This method for inter-sample position uₖ generation is applicable for both rational and non-rational SRC systems.

In a rational SRC system, the above algorithm may be further simplified for DSP or ASIC implementation. In particular,

$$\frac{{T}_{1}}{{T}_{2}}$$

may be approximated by the corresponding rational factor L/M. Thus, the overflow accumulator may be further simplified as:

$${index}_{k + 1} = {index}_{k} + \frac{L}{M}$$

and,
ov(m)=indexₖ+L>M

These proposed solutions for generating the inter-sample position uₖ in rational and non-rational SRC systems have two features. Firstly, two variables are applied, namely, the desired inter-sample position uₖ and the variable for the overflow accumulator indexₖ, whose relationship may be expressed as:

$${u}_{k} = 1 - \frac{{index}_{k}}{M}$$

Secondly, the range of inter-sample positions is defined as (0,1] instead of [0,1), to facilitate control of the system.

Variations of the proposed embodiments of the invention may be obtained by applying different initialization and updating methods to determine index and uₖ. A number of such variations are shown in Table 1.

In Table 1, the expression ov(m)=index>M?1:0 is C language notation and means that if index is greater than 1, then ov(m) equals 1, else ov(m) equals 0.

TABLE 1

| | Solutions Extended from the |
|---|---|
| Proposed solutions | literature |
| Init: index = 0, u_{g} = 0˜1, | Init: index = 0, u_{g} = 0˜1, |
| Update: | Update: |

| | |
|---|---|
| $\begin{matrix}index = index + L ; \\ {u}_{k} = 1 - \frac{index mod M}{M}\end{matrix}$ | $\begin{matrix}index = index + L ; \\ {u}_{k} = \frac{M - L}{M} - \frac{index mod M}{M}\end{matrix}$ |

| | |
|---|---|
| overflow: | overflow: |

| | |
|---|---|
| ov(m) = index > M?:0 | ov(m) = index > M?0 |
| if ov(m) = 1 | if ov(m) = 1 |
| index = index mod M | index = index mad M |

| | |
|---|---|
| Init: index = 0, u_{g} = 1.0, | $Init \text{:} index = 0 , {u}_{g} = \frac{M - L}{M} ,$ |
| Update: | Update: |

| | |
|---|---|
| $\begin{matrix}index = ( 1 - {u}_{k} ) M + L ; \\ {u}_{k} = 1 - \frac{index mod M}{M}\end{matrix}$ | $\begin{matrix}index = ( 1 - {u}_{k} ) M + L ; \\ {u}_{k} = 1 - \frac{index mod M}{M}\end{matrix}$ |

| | |
|---|---|
| overflow: | overflow: |

| | |
|---|---|
| ov(m) = index > M?1:0 | ov(m) = index > M?1:0 |
| if ov(m) = 1 | if ov(m) = 1 |
| index = index mod M | index = index mod M |

Two alternative embodiments are shown in Column 1 of Table 1, and these include the initialization of the system, the updating of the system and overflow accumulation. The first solution is suitable for DSP and ASIC implementation and simplifies the overflow accumulator as only an integer accumulator is required. The second solution is directly based on the update of uₖ, whose accumulator is more complicated, involving two adders and one multiplier. The finite word length effect of the second solution is more serious than the first one.

The methods listed in the second column of Table 1 are for comparison and verification. They are the counterparts which directly calculate the sequence of uₖ based on Equations (1) and (2) and FIG. 6 extended from the methods in the document by Tim Hentschel and Gerhard Fettweis entitled “Continuous-time digital filters for sample rate conversion in reconfigurable radio terminals”, Proc. of European Wireless 2000, Sep. 12-14, Dresden, German, pp55-59 and in the document by Tim Hentschel entitled “Sample rate conversion in software configurable radios”, Artech House, 2002.

In the methods listed in the second column of Table 1, the overflow condition is uₖ₊₁>uₖ and the inter-sample position meets the requirement of uₖε[0,1).

To verify the proposed methods embodying the invention, the transceiver system with programmable and dynamically reconfigurable common hardware as shown in FIG. 4 has been simulated. A generic differential PSK modulation scheme was adopted

$$( \frac{π}{2} - DBPSK , \frac{π}{4} - DQPSK , D8PSK ) .$$

In the transmitter, an over-sampling factor of 4 and a root raised cosine FIR filter with roll factor of 0.4 were used for the pulse shaping of transmitted signal. The functionality of the SRC and pulse shaping filter was implemented by the Farrow structure. The transmitted signal was passed through an AWGN channel. In the baseband section of the receiver, the received signal was first passed through a matched filter to maximize its received SNR, then it was down-sampled to symbol rate where the accurate symbol-timing phase was extracted. The transposed Farrow structure was applied to integrate the functions of the matched filter, the sample rate conversion and the symbol timing synchronization. Finally, the desired binary data were recovered by demodulating the sampled signal in the differential PSK demodulator.

In these simulations, the resultant system performance (BER) was considered as well as the spectrum property of the transposed Farrow structure.

The investigation of the spectrum property of the transposed Farrow structure as shown in the Tim Hentschel and Gerhard Fettweis document entitled “Continuous-time digital filters for sample rate conversion in reconfigurable radio terminals”, Proc. of European Wireless 2000, Sep. 12-14, Dresden, German, pp55-59, in the Matthias Henker and Gerhard Fettweis document entitled “Combined filter for sample rate conversion, matched filtering, and symbol synchronization in software radio terminals”, Proc. of European Wireless 2000, Sep. 12-14, Dresden, German, pp61-66, and in the Djordje Babic, Jussi Vesma, Tapio Saramaki, and Markku Renfors document entitled “Implementation of the Tranposed Farrow Structure”, Proc. of IEEE International Symposium on Circuits and Systems, 2002, ISCAS 2002, 26-29 May 2002,): ppIV-5-IV-8 vol. 4. is insufficient to ensure the correctness and feasibility of the derived transposed Farrow structure for practical applications. The reason for this is that the spectrum property of the transposed Farrow structure only depends on the coefficients of the transposed Farrow structure.

As described above, the proposal in the document by Matthias Henker and Gerhard Fettweis entitled “Combined filter for sample rate conversion, matched filtering, and symbol synchronization in software radio terminals”, Proc. of European Wireless 2000, Sep. 12-14, Dresden, German, pp61-66 is based on an incorrect mathematical basis. This can be further verified by investigating its BER performance. When this method is applied in the transposed Farrow structure, the whole system fails (and the BER of the system is always close to 0.5). Thus, this is not a feasible solution for SDR application.

The inter-sample position sequence does not affect the spectrum property, but substantially influences the timing of the filtered signal. For this reason, an ideal transceiver system implemented with conventional schemes was also simulated and its BER performance was obtained as a reference. In the simulation, both the up-sampling, and pulse shaping filter in the transmitter and the matched filter, down-sampling, and symbol timing adjustment in the receiver applied conventional polyphase multirate filter techniques of the type described in the document by Fredric J. Harris, Michael Rice entitled “Multirate digital filters for sysmbol timing synchronization in software defined radios”, IEEE Journal on Selected Areas in Communications, Vol. 19, No. 12, December 2002, pp2346-2357.

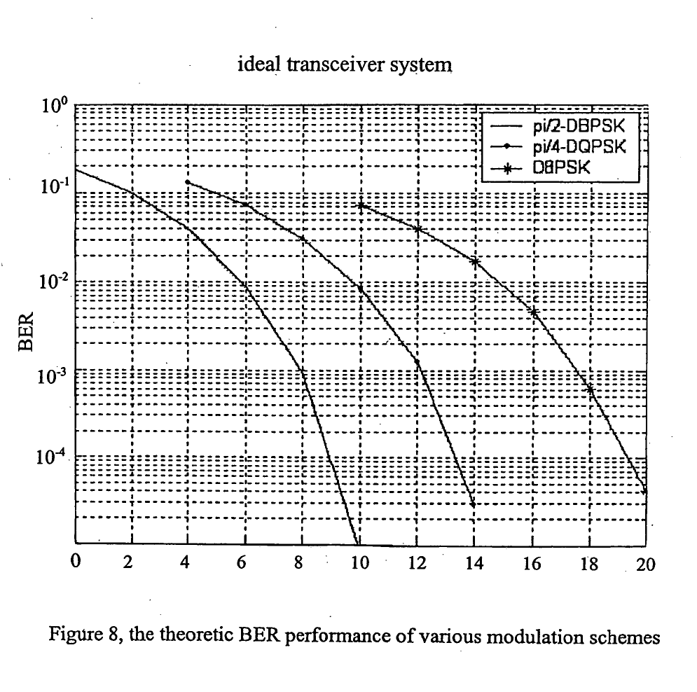

The BER performance of the reference system is shown in FIG. 8 with

$$\frac{π}{2} - DBPSK , \frac{π}{4} - DQPSK ,$$

D8PSK modulation.

It should be noted that in solution one (cell (1,1) in Table 1) the initialization of index instead of uₒ is the key, since uₖ is derived from the updated index. Thus uₒ can take any initial value between 0 and 1 and this will have little influence on the whole system. By contrast, in solution two (Cell (2,1) in Table 1), the initialization of uₒ is very important and must take the value of 1.0, and the update of index is based on uₖ and the overflow accumulation. Thus, in solution 2, the initialization of index is not particularly important, but it should be below the value of M to avoid the overflow.

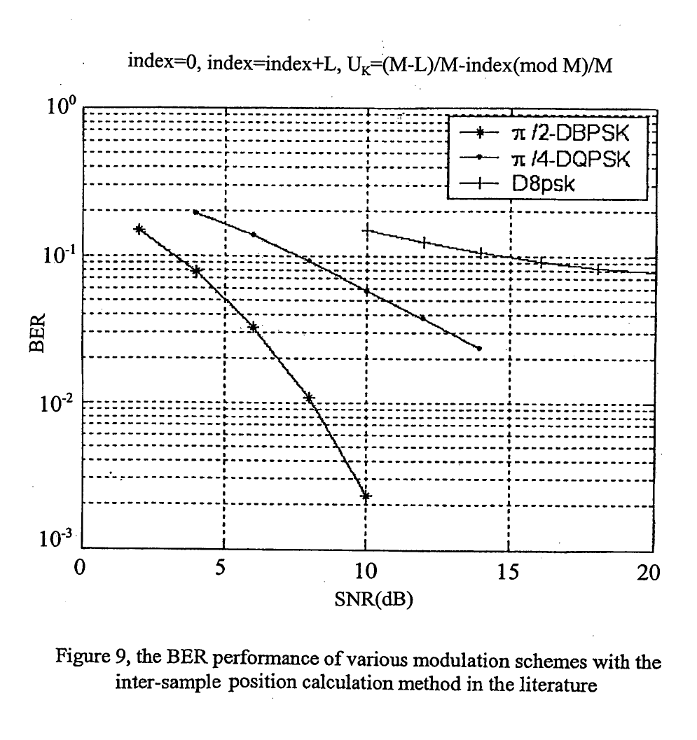

The two schemes extended from the prior art which are shown in the second column of Table 1, have the same BER performance and this is shown in FIG. 9.

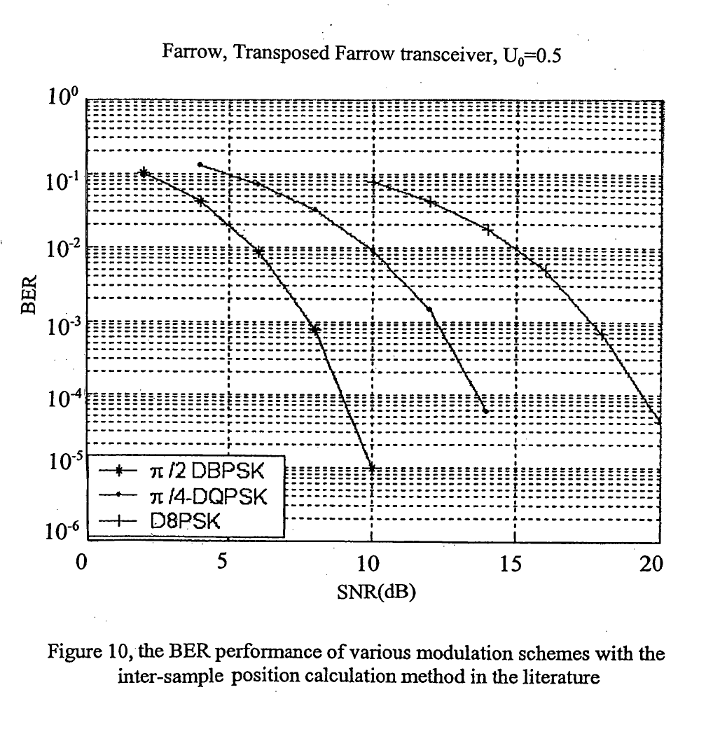

The BER performance of the two solutions embodying the invention which are set out in column 1 of Table 1, is substantially the same, as shown in FIG. 10. A comparison of FIG. 10 and FIG. 8 shows that the proposed transposed Farrow structure may achieve the same BER performance as the reference scheme.

A comparison of FIG. 9 with FIGS. 8 and 10, shows that the inter-sample position generation methods derived from the prior art result in significant performance degradation due to a constant timing phase error. This is the main limitation of the extensive application of transposed Farrow structure in software defined radio systems.

Various modifications to the embodiments of the present invention described above may be made. For example, other modules and method steps can be added or substituted for those above. Thus, although the invention has been described above using particular embodiments, many variations are possible within the scope of the claims, as will be clear to the skilled reader, without departing from the spirit and scope of the invention.

1. A receiver for a software defined radio (SDR) system comprising:
an input stage for receiving a transmitted signal;
an analogue-to-digital converter for converting the transmitted signal to a digital signal, the analogue-to-digital converter having a sample rate;
a filter matched to the received transmitted signal;
a sample rate converter for converting the digital signal output from the filter from an input sequence having the sample rate of the analogue-to-digital converter to an output sequence having an output sample rate defined by the received transmitted signal, the input sequence comprising a number of input samples, and the output sequence comprising a number of output samples;
a controller for controlling the output sample rate according to a predetermined timing sequence selected by the received transmitted signal; and
a demodulator coupled to the output of the sample rate converter for recovering said transmitted signal;
wherein the sample rate converter is implemented by a transposed Farrow structure; and
wherein said controller is arranged to reset the output sequence from the sample rate converter when any one of said number of input samples and any one of said number of output samples pass through coincidence in time.

2. The receiver of claim 1, further comprising:
a channel selection stage for selecting a channel associated with said transmitted signal; and
a symbol timing synchronisation stage, said symbol timing synchronisation stage being arranged to synchronise an output signal of the sample rate converter with said demodulator.

3. The receiver of claim 2, wherein one or more of the channel selection stage, the filter, the symbol timing synchronisation stage and the controller are implemented by a transposed Farrow structure.

4. The receiver of claim 1, wherein the controller comprises an accumulator overflow controller.

5. The receiver of claim 4, wherein the controller is arranged to reset the output sequence from the sample rate converter when the sum of the time interval between an output sample and a previous input sample and the ratio of the time interval between consecutive input samples to the time interval between consecutive output samples is greater than 1, which signifies that any one of said number of input samples and any one of said number of output samples pass through coincidence in time.

6. The receiver of claim 1, further comprising a memory store for storing at least one of:
a number of initialization values of the time interval between an output sample and a previous input sample; and
a number of initial values of a number of predetermined timing sequences to be selected by the received transmitted signal.

7. The receiver of claim 1, wherein the transposed Farrow structure comprises an updater for updating the time interval between an output sample and a subsequent input sample.

8. The receiver of claim 7, wherein the updater is arranged to update the time interval between an output sample and a subsequent input sample by subtracting the ratio of the time interval between consecutive input samples to the time interval between consecutive output samples from the value of the time interval between the previous output sample and previous input sample.

9. The receiver of claim 7, wherein the updater is arranged to update the time interval between an output sample and a subsequent input sample by adding the ratio of the time interval between consecutive input samples to the time interval between consecutive output samples to the value of the time interval between the previous output sample and previous input sample.

10. A transceiver for a software defined radio (SDR) system comprising the receiver according to claim 1.

11. A transceiver for a software defined radio system comprising the receiver according to claim 1, the transceiver further comprising a transmitter for transmitting signals to said receiver, said transmitter comprising a Farrow structure, said Farrow structure being arranged to implement one or more of digital up-conversion, pulse shaping and sample rate conversion.

12. A method for processing a received signal in a receiver of a software defined radio system, the method comprising the steps of:
receiving a transmitted signal;
converting the transmitted signal in an analogue-to-digital converter to a digital signal, the analogue-to-digital converter having a sample rate;
filtering said digital signal using a filter matched to the received transmitted signal;
converting in a sample rate converter the digital signal output from the filter from an input sequence having the sample rate of the analogue-to-digital converter to an output sequence having an output sample rate defined by the received transmitted signal, the input sequence comprising a number of input samples, and the output sequence comprising a number of output samples;
controlling the output sample rate according to a predetermined timing sequence selected by the received transmitted signal; and
demodulating the received transmitted signal in a demodulator coupled to the output of the sample rate converter for recovering said transmitted signal;
wherein the step of converting in a sample rate converter is implemented by a transposed Farrow structure; and
wherein the step of controlling the output sample rate comprises resetting the output sequence from the sample rate converter when any one of said number of input samples and any one of said number of output samples pass through coincidence in time.

13. The method of claim 12, further comprising:
selecting a channel associated with said transmitted signal; and
synchronising in a symbol timing synchronisation stage an output signal of the sample rate converter with said demodulator.

14. The method of claim 13, wherein one or more of the channel selection stage, the filter, the symbol timing synchronisation stage and the controller are implemented by a transposed Farrow structure.

15. The method of claim 12, wherein the step of controlling the output sample rate comprises controlling an accumulator overflow.

16. The method of claim 12, wherein the step of controlling the output sample rate comprises resetting the output sequence from the sample rate converter when the sum of the time interval between an output sample and a previous input sample and the ratio of the time interval between consecutive input samples to the time interval between consecutive output samples is greater than 1, which signifies that any one of said number of input samples and any one of said number of output samples pass through coincidence in time.

17. The method of claim 12, further comprising storing at least one of:
a number of initialization values of the time interval between an output sample and a previous input sample; and
a number of initial values of a number of predetermined timing sequences to be selected by the received transmitted signal.

18. The method of claim 12, further comprising updating the time interval between an output sample and a subsequent input sample using the transposed Farrow structure.

19. The method of claim 18, wherein the step of updating comprises updating the time interval between an output sample and a subsequent input sample by subtracting the ratio of the time interval between consecutive input samples to the time interval between consecutive output samples from the value of the time interval between the previous output sample and previous input sample.

20. The method of claim 18, wherein the step of updating comprises updating the time interval between an output sample and a subsequent input sample by adding the ratio of the time interval between consecutive input samples to the time interval between consecutive output samples to the value of the time interval between the previous output sample and previous input sample.

21. A method of transmitting and receiving signals in a software defined radio (SDR) system comprising the method according to claim 12.

22. A method of transmitting and receiving signals in a software defined radio (SDR) system comprising the method according to claim 12, further comprising transmitting signals from a transmitter to said receiver, said transmitter comprising a Farrow structure to implement one or more of digital up-conversion, pulse shaping and sample rate conversion.
